(19) United States
(12) Patent Application Publication
(10) Pub. No.: US 2018/0189017 A1
(43) Pub. Date: Jul. 5, 2018

(54) SYNCHRONIZED, MORPHING USER INTERFACE FOR MULTIPLE DEVICES WITH DYNAMIC INTERACTION CONTROLS

(71) Applicant: Entefy Inc., Palo Alto, CA (US)

(72) Inventors: Alston Ghafourifar, Los Altos Hills, CA (US); Brienne Ghafourifar, Los Altos Hills, CA (US)

(21) Appl. No.: 15/396,532

(22) Filed: Dec. 31, 2016

(51) Int. Cl. G06F 3/14; H04L 29/08

(52) U.S. Cl. CPC G06F 3/1454; H04L 67/306; G06F 3/0481; H04L 67/303; H04L 67/141

(57) ABSTRACT

Managing a user interface on multiple devices includes receiving, from a first device, an indication of a modification to a user interface of an application and a token associated with a user profile from which the user interface was modified, identifying a second device on which the user profile is associated with the application, and transmitting the token to the second device, wherein the token identifies how the user interface should be displayed on the second device to correspond to the modification.

### TECHNICAL FIELD

This disclosure relates generally to user interface presentation, and more specifically to real-time context generation and a blended input framework for morphing user interface manipulation and navigation, as well as synchronized morphing user interface for multiple devices.

### BACKGROUND

Computer software programs and other user-facing software applications (e.g., “Apps”) often have user interfaces that allow users to interact with the application using multiple types of user input, e.g., typing through a keyboard, mouse input, voice input, gestures, and the like. However, software-defined user interfaces often suffer from limitations in terms of practicality, accessibility, configurability, and utility. Current attempts often result in complicated software-defined interfaces with a limited extent of user configurability.

The user interface-related issues that arise with applications that can accept multiple types of user input are further complicated by users who engage in ‘multitasking’—both within a single software application on a single device and across devices. For example, it is not uncommon for a user to begin a task on one device, such as a laptop, and then wish to complete the task when another device is more convenient, such as a cell phone. Further, configurability of a user interface may be lost when a user moves from one device to another.

### BRIEF DESCRIPTION OF THE DRAWINGS

FIG. 1 is a block diagram illustrating a network architecture infrastructure, according to one or more embodiments.

FIG. 2 is a flowchart illustrating an exemplary method for generating device profiles, according to one or more embodiments.

FIG. 3 is a flowchart illustrating an exemplary method for modifying a user interface across multiple devices, according to one or more embodiments.

FIG. 4 shows an exemplary user interface, according to one or more embodiments.

FIG. 5 is a block diagram illustrating a blended input framework for morphing user interface manipulation and navigation, according to one or more embodiments.

FIG. 6 shows a flowchart illustrating an exemplary method for dynamically modifying a user interface based on user input, according to one or more embodiments.

FIG. 7 shows a flowchart illustrating an exemplary method for providing a blended input framework across multiple devices, according to one or more embodiments.

FIG. 8 is a block diagram illustrating an exemplary blended input framework, according to one or more embodiments.

### DETAILED DESCRIPTION

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

As used herein, the term “programmable device” can refer to a single programmable device or a plurality of programmable devices working together to perform the function described as being performed on or by the programmable device.

As used herein, the term “medium” refers to a single physical medium or a plurality of media that together store what is described as being stored on the medium.

As used herein, the term “user device” can refer to any programmable device that is capable of communicating with another programmable device across any type of network.

As used herein, the term “context” refers to a multi-dimensional understanding of the physical and/or virtual environment surrounding a user at a given time of any instruction, prompt, or other interaction. Additional details regarding context may be found in the commonly-assigned patent application bearing U.S. Ser. No. 15/396,481, which is hereby incorporated by reference in its entirety.

In one or more embodiments, a technique is provided which allows for dynamically modifying the presentation of data through a user interface based on real-time tracking of the context of a user's input. According to one or more embodiments, a user may submit a request to present data on a user device. The user may submit the request, for example, by voice, text, or Graphical Using Interface (GUI) selection. The request may be, for example, through voice input or textual input, and include a series of words. The series of words may be, for example, natural language input. A context may be assigned to or determined for the request. According to one or more embodiments, the context may indicate some information not explicitly provided in the request. The context may also indicate a task for which the request is intended. As an example, a user may be multitasking within a single software application, such as a multi-protocol, person-centric, multi-format inbox, concurrently writing an email while participating actively in a chat conversation. Certain information in the request may indicate that the request is intended for one task or the other, without the user directly identifying the target task in the request. The user interface may be modified based on the request to present the appropriate data via the user interface.

In one or more embodiments, a change in a user interface on one application within one device may trigger a change to a user interface on a corresponding application on one or more other devices (and potentially all of the devices) associated with a particular user. For example, a user may have a user profile that is utilized to manage all ‘events’ occurring across all devices which have been registered with the user's profile. An ‘event’ may be any action observed by the system, that takes place between a user and his/her device, connected 3^{rd} party accounts, contact, files, etc. In addition, according to one or more embodiments, an ‘event’ may be observed from a remote source, such as a central server or remote device. For example, an event may be observed as a user action to start drafting an email, or modifying a user interface on an application in some way. Events may be tied to a particular ‘context’ or collection of contexts. A ‘context’ may represent, for example, the full event of composing, address, and sending an email to Recipient or the general utilization of a particular sequence of functions in an application so as to manifest a certain activity or set of activities. According to one or more embodiments, the context may be identified, at least in part by person (such as the intended recipient of a message), or by service (such as activity between a given user and a registered Internet of Things (IoT) device such as a “smart thermostat” which may be used to dynamically control temperature in a user's home. Thus, a chat conversation with a person may be considered belonging to a first context that is shared for all conversations with the same person, as well as a second context which represents chat conversations with the person. There may be a third context representing an email conversation with the same person, which may be part of the first context, but not part of the second context. In one or more embodiments when a change to a user interface, or within a user interface, occurs on a first device, the device may generate a token with identifying information, such as a device identifier and an indication of the data that is presented and/or how the data is presented on the first device.

In one or more embodiments, the framework may also be used to modify a user interface on a local device (e.g., a laptop) using event data observed by the system on a remote device (e.g., a cell phone) when both devices are part of the same user profile. As an example, a user may request the local device to draft an email that includes a file that is not located on the local laptop and may have been accessed recently by the user in a previous session, but is located on the remote cell phone. Thus, the request may be transmitted to a central communications server, at which point, a designated worker application, also referred herein as a ‘Doer’ application, may direct the request to query the other active device(s) including the remote cell phone which may contain a more contemporaneous record of the file and its activity, per the event record as held in the global context manager, in order to locate the file. The file may be transferred to the local laptop device for use. Alternatively, the action may be taken by the device that has the file. As an example, the request may be sent to the central communications server to direct the cell phone to draft the email with the file attached. For the purposes of these embodiments, this collection of available contexts across devices can be considered part of an active session cache which does not in any way limit the ability for the system to analyze contexts and events that occur outside of the current session, but can simply be used to prioritize likely event associations. An active session cache may be a data store that includes a collection of events and/or contexts.

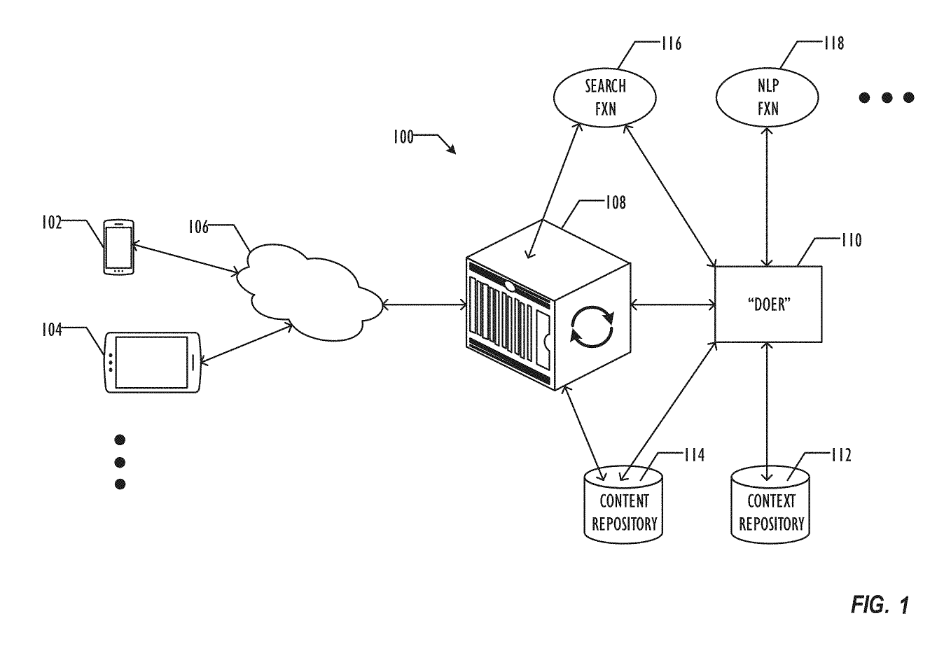

Referring now to FIG. 1, a block diagram illustrating a network architecture infrastructure, according to one or more embodiments, is presented. FIG. 1 shows an example of a central communications server infrastructure 100, according to some embodiments disclosed herein. According to some embodiments, central communications server infrastructure 100 may be responsible for storing, indexing, managing, searching, relating, and/or retrieving content (including communications messages and data files of all types) for the various users of the communication system. Infrastructure 100 may be accessed by any user device over various computer networks 106. Computer networks 106 may include many different types of computer networks available today, such as the Internet, a corporate network, or a Local Area Network (LAN). Each of these networks can contain wired or wireless devices and operate using any number of network protocols (e.g., TCP/IP). Networks 106 may be connected to various gateways and routers, connecting various machines to one another, represented, e.g., by central communications server 108, and various end user devices, including devices 102 (e.g., a mobile phone) and 104 (e.g., a tablet device). End user devices may also include computers, wearables, laptops, computer servers, etc.

Central communications server 108, in connection with various database(s), content repositories, subsystems, Application Programming Interfaces (APIs), etc., may serve as the central “brain” for the multi-protocol, multi-format communication system described herein. In particular, a so-called “Doer” 110 may be implemented as an activity manager program running on the central communications server that takes the various actions that the communications server 108 determines need to be performed, e.g., sending a message, storing a message, storing content, tagging content, indexing content, storing and relating contexts, etc. In some embodiments, the Doer 110 may be comprised of a plurality of individual programs, rules, and/or decision engines that determine what behavior(s) the activity manager should take.

In some embodiments described herein, data may be classified and stored, at various levels of detail and granularity, in what is known as “contexts.” The contexts may be stored in a context repository 112, which is accessible by Doer 110. Context repository 112 may be implemented as a running activity log, i.e., a running list of all relevant “things” that have happened, either directly or indirectly, to a given user via their use of the communications system. According to one or more embodiments, the context repository 112 may manage events, or “things,” based on user profile and device profile. Thus, it may be determined whether a particular event happened in device 102 or device 104.

In some embodiments, the Doer 110 is responsible for characterizing, relating, and tagging all information that gets stored in context repository 112. The various contexts and their relationships to other contexts may inform the system (and thus, the Doer 110) as to actions that should be taken (or suggested) to a user when that user faces a certain situation or scenario (i.e., when the user is in a certain context). For example, if context repository 112 has stored a context that relates to a user's search for “cars,” the next time the user is near a car dealership that sells cars of the type that the user had been searching for, the system may offer the user a notification that cars he has shown interest in are being offered for sale nearby or even present the search results from the last time the user searched for those cars. As another example, if the user brings up ‘cars’ during a later conversation, the prior search results may be relevant because the conversation may be about something the user saw in the search results. In some embodiments, the context repository 112 may employ probabilistic computations to determine what actions, things, events, etc. are likely to be related to one another.

In some embodiments, the Doer 110 is also in communication with a so-called content repository 114. Unlike context repository 112, which is effectively a log of all stored activities, the content repository 114 may be implemented as a unique, i.e., per-user, repository of all content related to a given user. The design of a particular user's context repository 112 may, e.g., be based on the user's patterns of behavior and communication and several other parameters relating to the user's preferences. Such patterns and parameters may take into account, e.g., who a user communicates with, where those parties are located, what smart devices and/or other connected services a user interacts with, etc. Because the design and makeup of the content repository 114 is a unique, i.e., per-user, structure, driven by each individual's personal interactions with the communication system, the system scales on a per-user basis, rather than on a per-network basis, as in traditional distributed systems or social graphs involving characteristics of multiple inter-related users.

In summary, the content repository 114 orchestrates and decides on behaviors for the system to take on behalf of a user (e.g., “The system should open an email message to Dave about cars.”); the Doer 110 actually implements or affects those decision to happen (e.g., directing the communication system's user interface to open an email message window, pre-populate the To: field of the email message with Dave's contact information, pre-populate the Subject: field of the email message with “Cars,” etc.); and the context repository 112 tracks all pieces of data that may related to this particular task (e.g., search for Dave's contact info, search for cars, compose a message to Dave, compose a message about cars, use Dave's email address to communicate with him, etc.). Thus, according to one or more embodiments, the collective system allows for a task to be completed in a particular manner that is based on historic behavior of the user.

The Doer 110 may also leverage various functionalities provided by the central communication system, such as a multi-protocol, multi-format search functionality 116 that, e.g., is capable of searching across all of a user's messages and content, or across a group of users' messages and content, or across the Internet to provide relevant search results to the task the user is currently trying to accomplish. The Doer 110 may also, e.g., leverage a Natural Language Processing (NLP) functionality 118 that is capable of intelligently analyzing and interpreting spoken or written textual commands for content, semantic meaning, emotional character, etc. With the knowledge gained from NLP functionality 118, the central communications server may, e.g., be able to suggest more appropriate responses, give more appropriate search results, suggest more appropriate communications formats and/or protocols, etc. In some embodiments, the Doer 110 may also synchronize data between the context repository 112 and the various sub-systems (e.g. search system 116 or NLP system 118), so that the context repository 112 may constantly be improving its understanding of which stored contexts may be relevant to the contexts that the user is now participating in (or may in the future participate in).

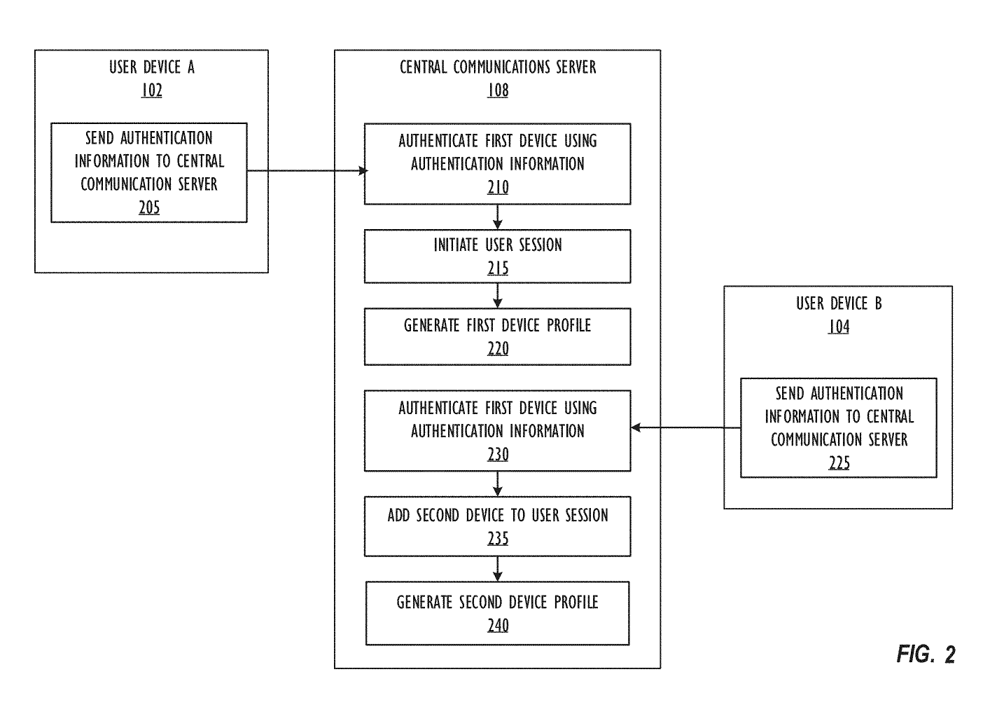

FIG. 2 is a flowchart illustrating an exemplary method for generating device profiles, according to one or more embodiments. For purposes of clarity, the various steps depicted in FIG. 2 are shown as occurring within user device A 102, user device B 104, and central communication server 108. However, according to one or more embodiments, the various steps may occur in alternative locations to those depicted. As an example, actions described as occurring by the central communication server 108 may involve other components, such as context repository 112 or Doer 110. Further, the various steps may occur in a different order, according to one or more embodiments. In addition, any of the various steps may be omitted, or may occur in parallel, according to one or more embodiments.

The method begins at 205, and the user device A 102 sends authentication information to the central communication server 108. According to one or more embodiments, the authentication information may identify a particular user on a device. Authentication information may allow the central communication server 108 to identify a particular user and the particular device A 102.

At 210, the central communications server 108 authenticates the user and the first user device using the authentication information. The central communications server 108 may provide authentication in a number of ways, such as a password, passcode, biometric information, or other data, which may be transmitted from user device A 102 to the central communications server 108.

The flowchart continues at 215 and the central communications server 108 initiates the user session. The central communications server 108 may begin tracking events and contexts once the session is initiated. Thus, user device A 102 may begin to transmit information about events occurring on the device to the central communications server 108. According to one or more embodiments, the central communications server 108 may manage several user profiles for each user, and devices associated with the user, interacting with the central communications server 108.

At 220, the central communications server 108 generates the first device profile. In one or more embodiments, the user profile may be used to track events and context specific to a particular device. The device profile may also allow a user to interact with the device from another remote device. Further, in one or more embodiments, the device profile identifies user devices that are active, and from which data may be shared or pulled from. According to one or more embodiments, the central communications server 108 manages a historic list of unique connected sessions.

The flowchart continues at 225, and user device B 104 sends authentication information to central communication server 108. Then at 230, the central communications server 108 authenticates the second device 104 using the received authentication information. The flowchart continues at 235 and the second device is added to the user session. Then, at 240, the central communications server 108 generates a second device profile. That is, according to one or more embodiments, the central communications server may manage events and contexts from a user interacting with multiple devices—either simultaneously or asynchronously. Further, because a user's interaction with some devices may differ from others, the device from which the event records are received is also monitored. According to one or more embodiments, upon registering a new device profile to the user profile, information about the device profile may be propagated to all other devices that are part of the user session, such as user device A 102.

In one or more embodiments, once the device profiles are established, the central communications server 108 may manage events that occur in the devices. The events may be tracked, analyzed, and received, from the individual user device A 102 and user device B 104. Alternatively, or additionally, the central communications server 108 may receive event information from the user device A 102 and user device B 104, and analyze and track the events on the central communications server 108, as described above.

According to one or more embodiments, once user device A 102 and user device B 104 have registered with the user session, then the central communication server 108 may mediate data or changes among interfaces in the various active devices.

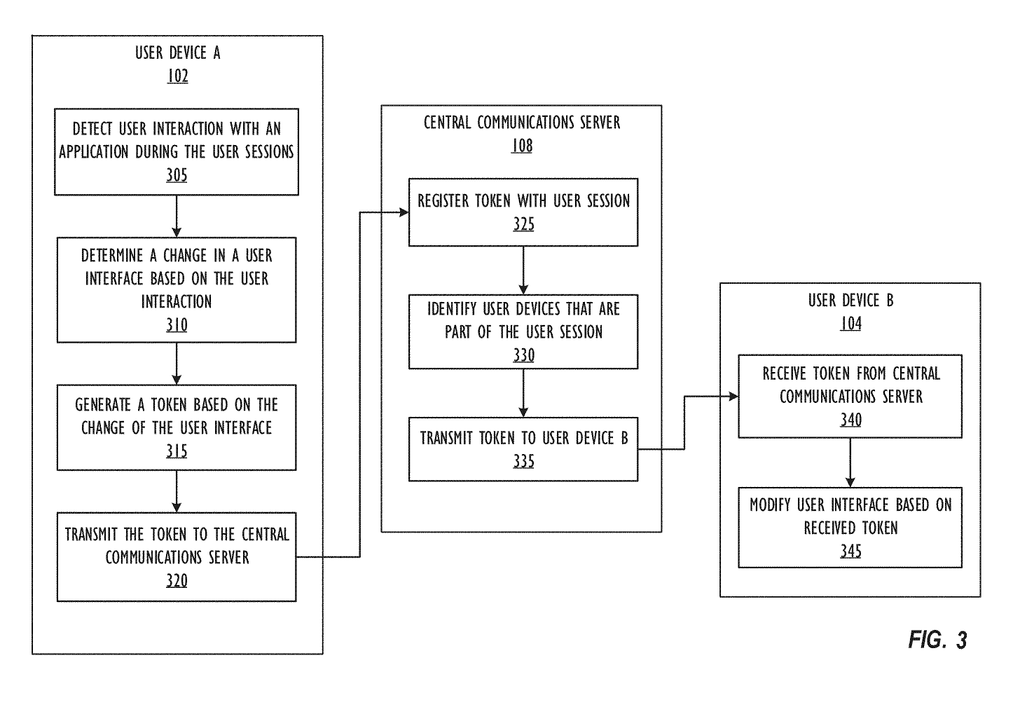

FIG. 3 is a flowchart illustrating an exemplary method for modifying a user interface across multiple devices, according to one or more embodiments. The flowchart begins at 305, and user device A 102 detects a user interaction with an application during the active user session. The user interaction may be any event that occurs between the user and the device. For example, the user may store or access an image, request the device to complete a task, modify a user interface for an application on the device, and the like.

The flowchart continues at 310, and user device A 102 determines a change in the user interface based on the user interaction. As an example, the user may change a layout of the user interface. As another example, the user may request data, or request an application on the user device A 102 to complete a task. The change in the user interface may define an event. In one or more embodiments, the event may be one that utilizes data or functionality of another device, such as device B 104. Further, the change the in the user interface may be one that should be propagated to other devices associated with the user profile, such as user device B 104.

At 315, user device A 102 generates a token based on the change of the use interface. In one or more embodiments, the token may include such information as a device identifier that identifies device A 102. The token may also indicate the data presented on the device, or data requested on the device. As an example, if the user requests, user device A 102 to send an image of a blue car, but the blue car is stored on user device B 104, then a token indicating the “change,” or the request to send the blue car, may be generated and sent to the central communications server for further processing. In one or more embodiments, the token may treat each device, session, function, and/or content item uniquely. Thus, the token may be utilized to dynamically control interface and resources across devices, and between user interfaces of multiple devices.

The flowchart continues at 320, and user device A 102 transmits the token to the central communications server 108. According to one or more embodiments, user device A 102 may transmit the request as received from the user. Further, according to one or more embodiments, user device A 102 may transmit some data indicative of the interaction. User device A 102 may also transmit some data indicating the interaction is coming from user device A 102, such as a device identifier.

At 325, the central communications server 108 registers the token with the user session. Further, according to one or more embodiments, central communications server 108 may store some indication of the interaction as an event in the context repository 112. The token may be registered such that it is propagated to one or more additional devices.

The flowchart continues at 330, and the central communications server 108 identifies user devices that are part of the user session 330. Then, at 335, the central communications server 108 transmits the token to user device B 104. According to one or more embodiments, the central communications server may not transmit the same token that was generated by user device A 102. Rather, the central communications server 102 may determine what data is required by user device B 104 in order to propagate the changes or requests determined in 310 to user device B 104.

At 340, user device B 104 receives the token from the central communications server 102. The flowchart terminates at 345, and user device B 104 modifies the user interface on user device B 104 based on the received token, or other information, received from central communications server 108. In one or more embodiments, the received information may indicate to user device B 104 how to modify a user interface or what data to manipulate in order to comply with the interaction received from the user at 305.

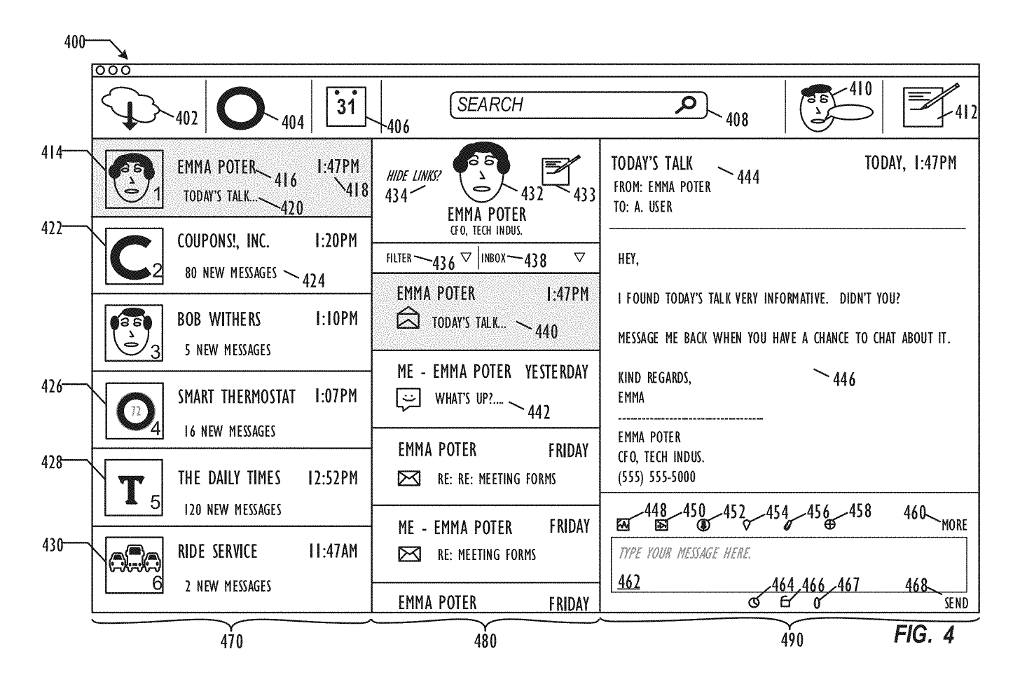

FIG. 4 shows an example of a multi-protocol, person-centric, multi-format inbox user interface 400, according to one or more disclosed embodiments. The inbox user interface 400 shown in FIG. 4 may, e.g., be displayed on the display of a mobile phone, laptop computer, wearable, or other computing device. The inbox user interface 400 may have a different layout and configuration based on the type of device and/or size of display screen that it is being viewed on, e.g., omitting or combining certain elements of the inbox user interface 400. In certain embodiments, elements of inbox user interface 400 may be interacted with by a user utilizing a touchscreen interface or any other suitable input interface, such as a mouse, keyboard, physical gestures, verbal commands, or the like. It is noted that the layout and content of user interface 400 has been selected merely for illustrative and explanatory purposes, and in no way reflects limitations upon or requirements of the claimed inventions, beyond what is recited in the claims.

As is shown across the top row of the user interface 400, the system may offer the user convenient access to several different repositories of personalized information. For example, icon 402 may represent a link to a personalized document repository page for a particular user. Such document repository may, e.g., comprise files shared between the particular user and the various recipients (e.g., email attachments, MMS media files, etc.). A user's personalized document repository may be fully indexed and searchable, and may include multimedia files, such as photos, in addition to other files, such as word processing and presentation documents or URL links.

Also shown in the top row of the user interface 400 is the icon 404, which may represent a link to all of the user of the inbox's interactions with other users, e.g., text messages, emails, voicemails, etc. The illustrative user interface 400 is shown as though the icon 404 had been selected by a user, i.e., the three main content panes (470, 480, and 490), as illustrated in FIG. 4, are presently showing the user of the inbox's interactions, for illustrative purposes.

Also shown in the top row of the user interface 400 is the icon 406, which may represent a link to the user of the inbox's calendar of events. This calendar may be synchronized across multiple devices and with multiple third party calendar sources (e.g., Yahoo!, Google, Outlook, etc.)

Also shown in the top row of the user interface 400 is a search box 408. This search box 408 may have the capability to universally search across, e.g.: all documents in the user's personalized document repository, all the user's historical interactions and their attachments, the user's calendar, etc. The search box 408 may be interacted with by the user via any appropriate interface, e.g., a touchscreen interface, mouse, keyboard, physical gestures, verbal commands, or the like.

Also shown in the top row of the user interface 400 is the icon 410, which may represent a chat icon to initiate a real-time ‘chatting’ or instant messaging conversation with one or more other users. As may now be appreciated, chat or instant messaging conversations may also be fully indexed and searchable, and may include references to multimedia files, such as photos, in addition to other files, such as word processing and presentation documents or URL links that are exchanged between users during such conversations. The system may also offer an option to keep such conversations fully encrypted from the central communications server, such that the server has no ability to index or search through the actual content of the user's communications, except for such search and index capabilities as offered via other processes, such as those described in the commonly-assigned patent application bearing U.S. Ser. No. 14/985,907 (“the '907 application”), which is hereby incorporated by reference in its entirety.

Also shown in the top row of the user interface 400 is the icon 412, which may represent a compose message icon to initiate the drafting of a message to one or more other users. As will be described in greater detail below, the user may enter (and send) his or her message in any desired communications format or protocol that the system is capable of handling. Once the message has been composed in the desired format, the user may select the desired delivery protocol for the outgoing communication. Additional details regarding functionality for a universal, outgoing message composition box that is multi-format and multi-protocol may be found in the commonly-assigned patent application bearing U.S. Ser. No. 14/141,551 (“the '551 application”), which is hereby incorporated by reference in its entirety.

As may be understood, the selection of desired delivery protocol may necessitate a conversion of the format of the composed message. For example, if a message is entered in audio format, but is to be sent out in a text format, such as via the SMS protocol, the audio from the message would be digitized, analyzed, and converted to text format before sending via SMS (i.e., a speech-to-text conversion). Likewise, if a message is entered in textual format, but is to be sent in voice format, the text from the message will need to be run through a text-to-speech conversion program so that an audio recording of the entered text may be sent to the desired recipients in the selected voice format via the appropriate protocol, e.g., via an email message.

As is shown in the left-most content pane 470, the multi-format, multi-protocol messages received by a user of the system may be combined together into a single, unified inbox user interface, as is shown in FIG. 4. Row 414 in the example of FIG. 4 represents the first “person-centric” message row in the user's unified inbox user interface. As shown in FIG. 4, the pictorial icon and name 416 of the sender whose messages are aggregated in row 414 appear at the beginning of the row. The pictorial icon and sender name indicate to the user of the system that all messages that have been aggregated in row 414 are from exemplary user ‘Emma Poter.’ Note that any indication of sender may be used. Also present in row 414 is additional information regarding the sender ‘Emma Poter,’ e.g., the timestamp 418 (e.g., 1:47 pm in row 414), which may be used to indicate the time at which the most recently-received message has been received from a particular sender, and the subject line 420 of the most recently-received message from the particular sender. In other embodiments, the sender row may also provide an indication 424 of the total number of message (or total number of ‘new’ or ‘unread’ messages) from the particular sender. Additional details regarding functionality for a universal, person-centric message inbox that is multi-format and multi-protocol may be found in the commonly-assigned patent application bearing U.S. Ser. No. 14/168,815 (“the '815 application”), which is hereby incorporated by reference in its entirety.

Moving down to row 422 of inbox user interface 400, messages from a second user, which, in this case, happens to be a company, “Coupons!, Inc.,” have also been aggregated into a single row of the inbox feed. Row 422 demonstrates the concept that the individual rows in the inbox feed are ‘sender-centric,’ and that the sender may be any of: an actual person (as in row 414), a company (as in rows 422 and 428), a smart, i.e., Internet-enabled, device (as in row 426), or even a third-party service that provides an API or other interface allowing a client device to interact with its services (as in row 430). Additional details regarding functionality for universally interacting with people, devices, and services via a common user interface may be found in the commonly-assigned patent application bearing U.S. Ser. No. 14/986,111 (“the '111 application”), which is hereby incorporated by reference in its entirety.

As may now be appreciated, the multi-protocol, person-centric, multi-format inbox user interface 400 of FIG. 4 may provide various potential benefits to users of such a system, including: presenting email, text, voice, video, and social messages all grouped/categorized by contact (i.e., ‘person-centric,’ and not subject-people-centric, subject-centric, or format-centric); providing several potential filtering options to allow for traditional sorting of communications (e.g., an ‘email’ view for displaying only emails); and displaying such information in a screen-optimized feed format. Importantly, centralization of messages by contact may be employed to better help users manage the volume of incoming messages in any format and to save precious screen space on mobile devices (e.g., such a display has empirically been found to be up to six to seven times more efficient that a traditional inbox format). Further, such an inbox user interface makes it easier for a user to delete unwanted messages or groups of messages (e.g., spam or graymail). The order of appearance in the inbox user interface may be customized as well. The inbox user interface may default to showing the most recent messages at the top of the feed. Alternatively, the inbox user interface may be configured to bring messages from certain identified “VIPs” to the top of the inbox user interface as soon as any message is received from such a VIP in any format and/or via any protocol. The inbox user interface may also alert the user, e.g., if an email, voice message, and text have all been received in the last ten minutes from the same person—likely indicating that the person has an urgent message for the user. The inbox user interface may also identify which companies particular senders are associated with and then organize the inbox user interface, e.g., by grouping all communications from particular companies together. In still other embodiments, users may also select their preferred delivery method for incoming messages of all types. For example, they can choose to receive their email messages in voice format or voice messages in text, etc.

As is displayed in the central content pane 480 of FIG. 4, the selection of a particular row in the left-most content pane 470 (in this case, row 414 for ‘Emma Poter’ has been selected, as indicated by the shading of row 414) may populate the central content pane 480 with messages sent to and/or from the particular selected sender. As shown in FIG. 4, central content pane 480 may comprise a header section 432 that, e.g., provides more detailed information on the particular selected sender, such as their profile picture, full name, company, position, etc. The header section may also provide various abilities to filter the sender-specific content displayed in the central content pane 480 in response to the selection of the particular sender. For example, the user interface 400 may provide the user with the abilities to: show or hide the URL links that have been sent to or from the particular sender (434); filter messages by some category, such as protocol, format, date, attachment, priority, etc. (436); and/or filter by different message boxes, such as, Inbox, Sent, Deleted, etc. (438). The number and kind of filtering options presented via the user interface 400 is up to the needs of a given implementation. The header section 432 may also provide a quick shortcut 433 to compose a message to the particular selected sender.

The actual messages from the particular sender may be displayed in the central pane 480 in reverse-chronological order, or whatever order is preferred in a given implementation. As mentioned above, the messages sent to/from a particular sender may comprise messages in multiple formats and sent over multiple protocols, e.g., email message 440 and SMS text message 442 commingled in the same messaging feed.

As is displayed in the right-most content pane 490 of FIG. 4, the selection of a particular row in the center content pane 480 (in this case, row 440 for ‘Emma Poter’ comprising the email message with the Subject: “Today's Talk” has been selected, as indicated by the shading of row 440) may populate the right-most content pane 490 with the actual content of the selected message. As shown in FIG. 4, the right-most content pane 490 may comprise a header section 444 that, e.g., provides more detailed information on the particular message selected, such as the message subject, sender, recipient(s), time stamp, etc. The right-most content pane 490 may also provide various areas within the user interface, e.g., for displaying the body of the selected message 446 and for composing an outgoing response message 462.

Many options may be presented to the user for drafting an outgoing response message 462. (It should be noted that the same options may be presented to the user when drafting any outgoing message, whether or not it is in direct response to a currently-selected or currently-displayed received message from a particular sender). For example, the user interface 400 may present an option to capture or attach a photograph 448 to the outgoing message. Likewise, the user interface 400 may present options to capture or attach a video 450 or audio recording 452 to the outgoing message. Other options may comprise the ability to: attach a geotag 454 of a particular person/place/event/thing to the outgoing message; add a file attachment(s) to the outgoing message 456, and/or append the user's current GPS location 458 to the outgoing message. Additional outgoing message options 460 may also be presented to the user, based on the needs of a given implementation.

Various outgoing message sending options may also be presented to the user, based on the needs of a given implementation. For example, there may be an option to send the message with an intelligent or prescribed delay 464. Additional details regarding delayed sending functionality may be found in the commonly-assigned patent application bearing U.S. Ser. No. 14/985,756 (“the '756 application”), which is hereby incorporated by reference in its entirety. There may also be an option to send the message with in a secure, encrypted fashion 466, even to groups of recipients across multiple delivery protocols. Additional details regarding the sending of secured messages across delivery protocols may be found in the commonly-assigned patent application bearing U.S. Ser. No. 14/985,798 (“the '798 application”), which is hereby incorporated by reference in its entirety. There may also be an option to send the message using a so-called “Optimal” delivery protocol 467.

The selection of the “Optimal” delivery option may have several possible implementations. The selection of output message format and protocol may be based on, e.g., the format of the incoming communication, the preferred format or protocol of the recipient and/or sender of the communication (e.g., if the recipient is an ‘on-network’ user who has set up a user profile specifying preferred communications formats and/or protocols), an optimal format or protocol for a given communication session/message (e.g., if the recipient is in an area with a poor service signal, lower bit-rate communication formats, such as text, may be favored over higher bit-rate communications formats, such as video or voice), and/or economic considerations of format/protocol choice to the recipient and/or sender (e.g., if SMS messages would charge the recipient an additional fee from his or her provider, other protocols, such as email, may be chosen instead).

Other considerations may also go into the determination of an optimal delivery option, such as analysis of recent communication volume, analysis of past communication patterns with a particular recipient, analysis of recipient calendar entries, and/or geo-position analysis. Other embodiments of the system may employ a ‘content-based’ determination of delivery format and/or protocol. For example, if an outgoing message is recorded as a video message, SMS may be de-prioritized as a sending protocol, given that text is not an ideal protocol for transmitting video content. Further, natural language processing (NLP) techniques may be employed to determine the overall nature of the message (e.g., a condolence note) and, thereby, assess an appropriate delivery format and/or protocol. For example, the system may determine that a condolence note should not be sent via SMS, but rather translated into email or converted into a voice message. Additional details regarding sending messages using an Optimal delivery protocol may be found in the commonly-assigned patent application bearing U.S. Ser. No. 14/985,721 (“the '721 application”), which is hereby incorporated by reference in its entirety.

Another beneficial aspect of the multi-protocol, multi-format outgoing message composition system described herein is the ability to allow the user to send one message to the same recipient in multiple formats and/or via multiple protocols at the same time (or with certain formats/protocols time delayed). Likewise, the multi-protocol, multi-format outgoing message composition system also allows the user the ability to send one message to multiple recipients in multiple formats and/or via multiple protocols. The choice of format/protocol for the outgoing message may be made by either the system (i.e., programmatically) or by the user, e.g., by selecting the desired formats/protocols via the user interface of the multi-protocol, multi-format communication composition system.

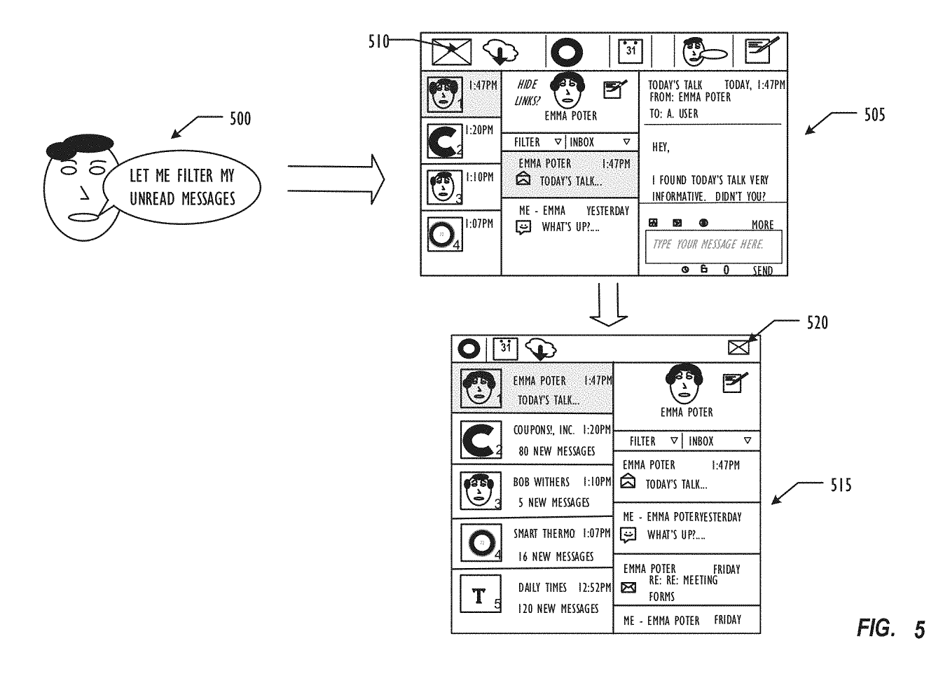

FIG. 5 is a block diagram illustrating a blended input framework for morphing user interface manipulation and navigation, according to one or more embodiments. According to one or more embodiments, FIG. 5 depicts a user 500 requesting a modification to a user interface on a first device, and the change propagating to additional devices registered to the user profile for user 500. For purposes of explanation, user interface 505 and user interface 515 depict exemplary variations of user interface 400. For example, user interface 505 may be an interface on a tablet device, whereas interface 515 may be an interface on a mobile phone.

As depicted in the example, user 500 may request for the user interface 505 to allow him to filter his messages by unread messages. As a result, user interface 505 may include an additional icon 510, which depicts an unopened envelope that, when selected, would allow the user 500 to filter by unread messages. According to one or more embodiments, the option to modify the user interface to add icon 510 may be explicitly offered visually to the user (e.g., through a menu interface or other customized option-setting interface), or may not be explicitly offered visually to the user. That is, through some other form of user input (e.g., verbal input or gesture input), user interface 505 may provide the ability to utilize functionality that is not otherwise explicitly provided visually as an option to the user through the user interface.

According to one or more embodiments, an event and context may be stored based on the request between user 500 and the user interface 505. For example, if user interface 505 is part of user device A 102, then user device A 102 may store the event and details surrounding the event. Further, in one or more embodiments, user device A 102 may propagate the event to the central communications server 108 In one or more embodiments, the change to the user interface may be packaged and transmitted in the form of a token, as described above. Then, according to one or more embodiments, additional user devices registered with the user profile may be identified and the token may be propagated. Thus, the token, or other information related to the change in the user interface, may be transmitted to user device B 104.

For purposes of the example, user interface 515 may be a user interface on user device B 104. As depicted, user device B 104 may modify user interface 515 to include the icon 520, which may allow the use 500 to filter unread messages (similarly to the additional icon 510 added to user interface 505, described above). In one or more embodiments, user device B 104 may additionally generate an event record locally. The event record may indicate, for example, that at a particular time, in the particular user interface, user 500 modified the user interface to add an icon to filter unread messages. Further, in one or more embodiments, user device B 104 may send the event record with other identifying information. Thus, the event and corresponding context may be tracked locally within user device B 102 and central communications server 108.

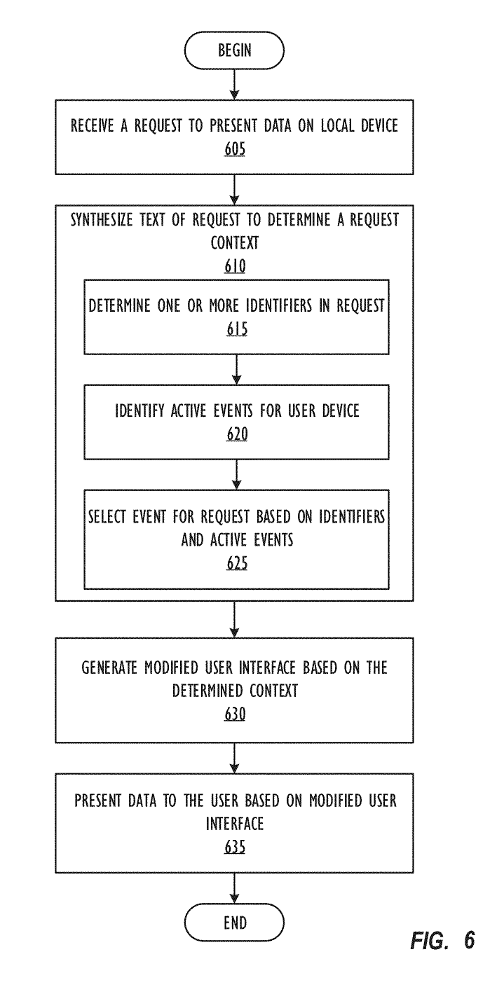

FIG. 6 shows a flowchart illustrating an exemplary method for dynamically modifying a user interface based on user input, according to one or more embodiments. Specifically, according to one or more embodiments, FIG. 6 presents an exemplary flowchart detailing how a request is processed locally.

The flowchart begins at 605, and a request is received to present data on a local device. According to one or more embodiments, the request may be received from a user using any type of input. For example, the request may be entered using a real or virtual keyboard, mouse input, audio input, gesture input, or the like. According to one or more embodiments, the user interface may be configured to be able to received inputs of multiple types at the same time.

The flowchart continues at 610 and a device synthesizes the text of the request to determine a request context. In one or more embodiments, the synthesis may be done at a local device, such as user device A 102 or user device B 104. In addition, according to one or more embodiments, the synthesis may be done on the central communications server 108. According to one or more embodiments, the user input may be received in a natural language format, and require analysis to determine the specific action requested by the user. Further, because a user may be multitasking, the event to which the request is directed may also need to be identified.

In one or more embodiments, synthesizing the text of the request may include some sub-steps. As depicted, synthesizing text of the request to determine a request context may include, at 615, determining one or more identifiers in the request. Identifiers may be, for example, verbs and adverbs that express the requested action, or, nouns or pronouns that identify people or things which are affected by the action. The identifiers may be words in the request that may provide information regarding the event, actors, subjects, actions, and the like that are needed to complete the request.

The flowchart continues at 620, and active events are identified for the user device. According to one or more embodiments, detecting active events may be useful for determining a request context. In one or more embodiments, the local device, such as user device A 102 and user device B 104 may keep a list of actions that occur locally. Those events may be clustered or organized by common attributes to identify a particular context. A context may be, for example, an active event. An example of an active event may be, for example, a user drafting an email, or a particular chat conversation. According to one or more embodiments, a user may be typing an email at the same time as they input a voice request to send a chat message. Thus, in one or more embodiments, the identifiers may be used to help determine if the request corresponds to a current event, or to another active event on the user device. At 625, an event is selected for the request based on the identifiers and the active events.

The flowchart continues at 630, and a modified user interface is generated based on the determined content. In one or more embodiments, the actual layout of the user interface may be modified, or the user interface may be modified by presenting data or taking some other action within the user interface. Thus, if the user has been multitasking and the identified active event is used, then the modified user interface may include switching to the determined active event rather than the current event in order to complete the request. The flowchart terminates at 635 and the local device presents the data to the user based on the modified user interface.

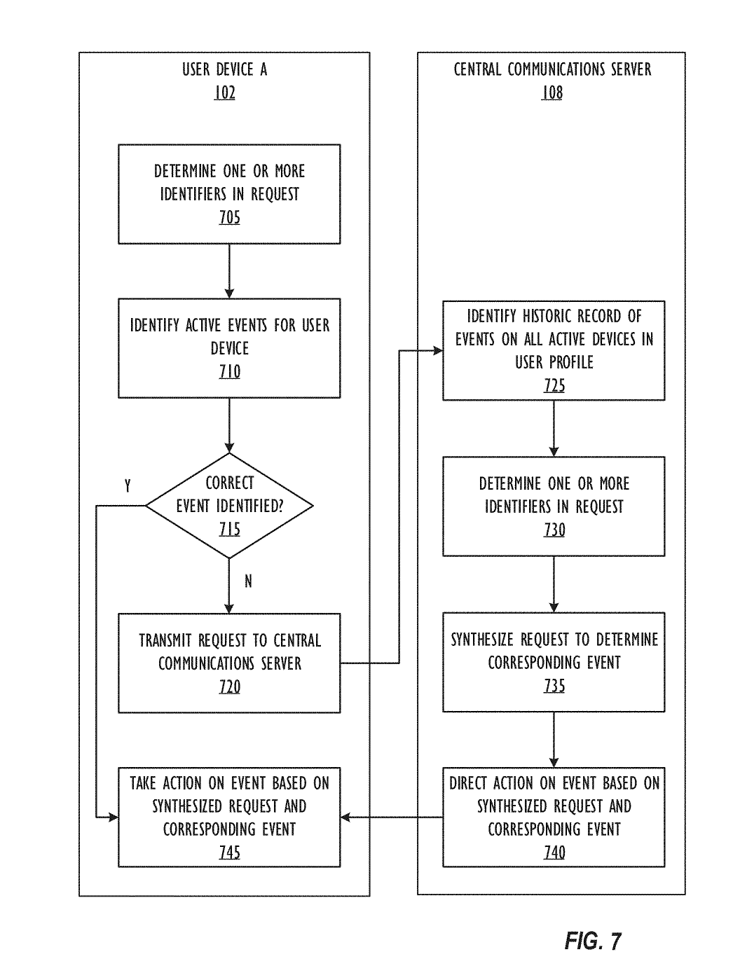

FIG. 7 shows a flowchart illustrating an exemplary method for providing a blended input framework across multiple devices, according to one or more embodiments. The flowchart depicts an alternative, or addition, to 615-625 of FIG. 6. According to one or more embodiments, the blended input framework allows for users to multitask within and among devices, using a variety of input types. For purposes of the example, the various steps are depicted as occurring in user device A 102 and central communications server 108. However, in one or more embodiments, the various steps may occur in different components. Further, the various steps may occur in a different order, or some may be omitted, or occur in parallel.

The flowchart begins at 705 and user device A 102 determines one or more identifiers in a request. As described above, the identifiers may be words in the natural language request that may be used to identify actions, actors, subjects, and the like within the request. The identifiers may explicitly identify the items, or may be used to determine, based on the stored context information for the user profile, actions, actors, subjects, and the like.

At 710, user device A 102 identifies active events for the user device. A determination is made at 715 regarding whether the correct event has been identified. According to one or more embodiments, the determination regarding whether the correct event has been identified may be based on a threshold confidence value that indicates how likely it is that the identified for which the request is intended has been identified. If, at 715 it is determined that the correct event has been identified, then the flowchart continues at 745 and user device A 102 may take action on the event based on the synthesized request and the corresponding event.

Returning to 715, if it is determine that the correct event has not been identified, then the flowchart continues at 720. According to one or more embodiments, if the correct event was unable to be identified by the user device A 102, then at 720, user device A 102 transmits the request to the central communications server 720. In one or more embodiments, the request may be the request received from a user, or may be a synthesized version of the request. In addition, additional data may be transmitted with the request. As an example, identifying data associated with user device A 102 may be transmitted, or data used by user device A 102 to detect a context may be sent to the central communications server 108.

The flow chart continues at 725, and the central communications server 108 identifies a historic record of events of all devices associated with the user profile. In one or more embodiments, the central communication server 108 may track events across devices registered with a user profile. The events may include various attributes, which may be linked to identify common contexts.

At 730, the central communications server 108 determines one or more identifiers in the request. The identifiers may be determined based on data received from user device A 102, or may be separately identified by an analysis performed by the central communications server. That is, according to one or more embodiments, if the particular subject, actor, action, or the like is not explicitly included in the request, the central communications server may have more information than the local device to determine the proper context based on global user activity across devices. The flowchart continues at 735 and the central communications server 108 synthesizes the request to determine the corresponding event.

At 740, the central communications server 108 directs action on the event based on the synthesized request and the corresponding event. Then, the flowchart terminates at 745, where the user device A 745 takes action based on the direction of central communications server 108. According to one or more embodiments, it may be more optimal, e.g., from a processing efficiency or power efficiency standpoint, for another device to take the action on the event. Thus, in an alternative embodiment, at 740, the central communications server 108 may direct an alternate device, such as user device B 104 to complete the action.

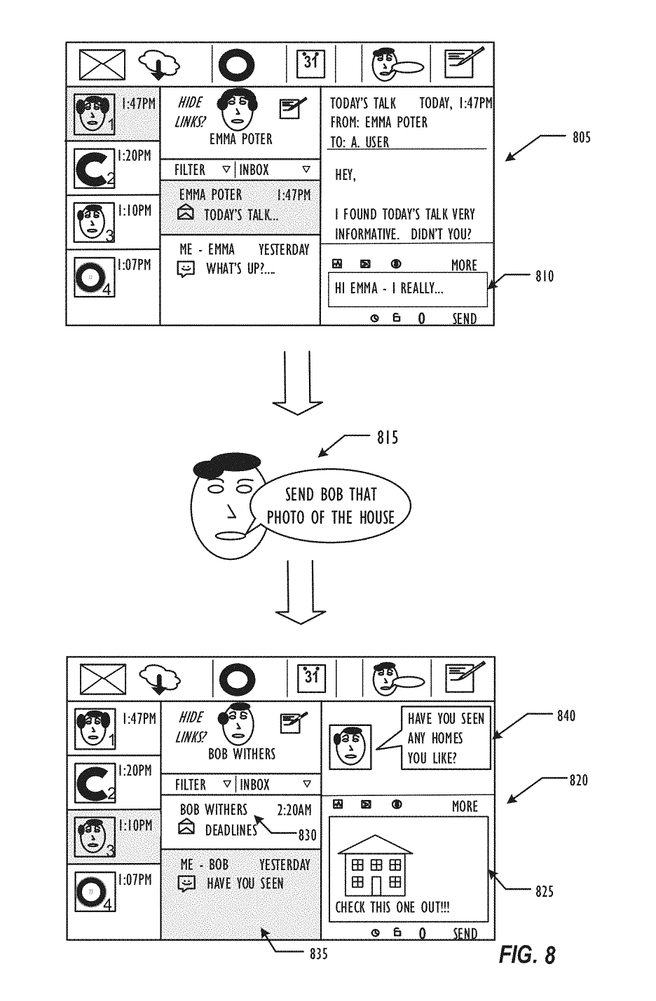

FIG. 8 is a block diagram illustrating an exemplary blended input framework, according to one or more embodiments. The block diagram illustrates a timeline of a user interacting with a user interface for a local device, such as user device A 102. User interface 805 depicts a first version of the user interface, wherein a user is typing an email to Emma Poter in text box 810. Then, at 815, the user uses voice input to instruct the user interface to “send Bob that photo of the house.” According to one or more embodiments, the device may determine identifiers in the request. For example, “send” may indicate that data should be transmitted. “Bob” may indicate that a user named Bob may be the intended recipient of the transmission. “that photo” may indicate that there is a preexisting photo that should be the subject of the “send” action. “the house” indicates that the photo should include a house.

Further, as described above with respect to FIG. 7, the local device or the central communications server may determine whether the request is associated with an active event. The pictorial icons on the left side of the interface identify Bob Withers (shown in Row 3) is a person named “Bob,” with whom the user has recently interacted. As shown in user interface 820, there may be several types of ongoing events associated with Bob Withers. As shown, there is an ongoing email conversation with Bob Withers regarding deadlines, as shown at 830. There is also an ongoing chat conversation with Bob Withers regarding homes, as shown in 835, and the expanded version in 840. Thus, the local user device A 102 or the central communications server 108 may identify the chat conversation as the likely context in which the photo should be sent to Bob Withers.

According to one or more embodiments, the photo may be found locally on the user device A 102, or on a remote user device, such as user device B 104. If the photo is located on user device B 104, local user device A 102 may utilize the token system to request the photo from the remote device. As an example, the request or token associated with the request may be transmitted to the central communications server 108, which may interface with user device B 104 in order to obtain an image of a house which likely should be sent to Bob Withers.

The local user interface 820 may be modified to include the image in a draft message 825 to Bob Withers, in the chat conversation, which may be determined to be the most relevant ongoing conversation with Bob Withers based on the context of the request. Further, in one or more embodiments, based on data or resources of the user devices registered with the user session, it may be more optimal for the message to be generated and transmitted by user device B 104. Thus, according to one or more embodiments, the central communications server 108 may direct user device B 104 to draft and send the message to Bob Withers.

It is to be understood that the above description is intended to be illustrative, and not restrictive. For example, the above-described embodiments may be used in combination with each other. As another example, the above-described flow diagrams include a series of actions which may not be performed in the particular order depicted in the drawings. Rather, the various actions may occur in a different order, or even simultaneously. Further, the various actions may occur in a different grouping, or by different devices. Many other embodiment will be apparent to those of skill in the art upon reviewing the above description. The scope of the invention should therefore be determined with reference to the appended claims, along with the full scope of equivalents to which such claims are entitled.

What is claimed is:

1. A computer readable medium comprising computer readable code executable by one or more processors to:
receive, from a first device, an indication of a modification to a user interface of an application and a token associated with a user profile from which the user interface was modified;
identify a second device on which the user profile is associated with the application; and
transmit the token to the second device, wherein the token identifies how the user interface should be displayed on the second device to correspond to the modification.

2. The computer readable medium of claim 1, further comprising computer readable code to:
receive an indication of a request on the first device for a file stored on the second device;
obtain the file from the second device; and
provide the file to the first device for presentation.

3. The computer readable medium of claim 1, further comprising computer readable code to, prior to receiving the indication of a modification to the user interface:
receive authentication information for the user profile;
authenticate the first device using the authentication information; and
initiate a user session for the user profile in response to the authentication.

4. The computer readable medium of claim 3, further comprising computer code to:
generate a first device profile for the first device in response to authenticating the first device.

5. The computer readable medium of claim 4, wherein the computer readable code to identify a second device on which the user profile is associated with the application further comprises computer readable code to:
determine that the second device is authenticated for the user session; and
generate a second device profile for the second device and the user session.

6. The computer readable medium of claim 5, further comprising computer readable code to:
specify a session cache for the user session, wherein the session cache comprises actions from the first device and the second device during the user session.

7. The computer readable medium of claim 5, further comprising computer readable code to:
receive a request from the first device to end the user session on the second device; and
in response to the request from the first device to end the user session on the second device, removing the second device from the user session.

8. A system for managing a user interface on multiple devices, comprising:
one or more processors; and
a memory coupled to the one or more processors and comprising computer readable code executable by the one or more processors to cause the system to:
receive, from a first device, an indication of a modification to a user interface of an application and a token associated with a user profile from which the user interface was modified;
identify a second device on which the user profile is associated with the application; and
transmit the token to the second device, wherein the token identifies how the user interface should be displayed on the second device to correspond to the modification.

9. The system of claim 8, further comprising computer readable code to cause the system to:
receive an indication of a request on the first device for a file stored on the second device;
obtain the file from the second device; and
provide the file to the first device for presentation.

10. The system of claim 8, further comprising computer readable code executable by the one or more processors to cause the system to, prior to receiving the indication of a modification to the user interface:
receive authentication information for the user profile;
authenticate the first device using the authentication information; and
initiate a user session for the user profile in response to the authentication.

11. The system of claim 10, further comprising computer readable code executable by the one or more processors to cause the system to:
generate a first device profile for the first device in response to authenticating the first device.

12. The system of claim 11, wherein the instructions to identify a second device on which the user profile is associated with the application further comprises instructions to:
determine that the second device is authenticated for the user session; and
generate a second device profile for the second device and the user session.

13. The system of claim 12, further comprising computer readable code to:
specify a session cache for the user session, wherein the session cache comprises actions from the first device and the second device during the user session.

14. The system of claim 12, further comprising computer readable code to:
receive a request from the first device to end the user session on the second device; and
in response to the request from the first device to end the user session on the second device, remove the second device from the user session.

15. A method for managing a user interface on multiple devices, comprising:
receiving, from a first device, an indication of a modification to a user interface of an application and a token associated with a user profile from which the user interface was modified;
identifying a second device on which the user profile is associated with the application; and
transmitting the token to the second device, wherein the token identifies how the user interface should be displayed on the second device to correspond to the modification.

16. The method of claim 15, further comprising:
receiving an indication of a request on the first device for a file stored on the second device;
obtaining the file from the second device; and
providing the file to the first device for presentation.

17. The method of claim 15, further comprising, prior to receiving the indication of a modification to the user interface:
receiving authentication information for the user profile;
authenticating the first device using the authentication information; and
initiating a user session for the user profile in response to the authentication.

18. The method of claim 17, further comprising:
generating a first device profile for the first device in response to authenticating the first device.

19. The method of claim 18, wherein identifying a second device on which the user profile is associated with the application further comprises:
determining that the second device is authenticated for the user session; and
generating a second device profile for the second device and the user session.

20. The method of claim 19, further comprising:
specifying a session cache for the user session, wherein the session cache comprises actions from the first device and the second device during the user session.
